(19) United States
(12) Patent Application Publication
(10) Pub. No.: US 2026/0101100 A1
(43) Pub. Date: Apr. 9, 2026

(54) LENS MODULE AND ELECTRONIC DEVICE FOR IMPROVING AN IMAGE QUALITY OF THE LENS MODULE

(71) Applicant: Newmax Technology Co., Ltd., Taichung City (TW)

(72) Inventors: Yung-Fu LIANG, Taichung City (TW); Chiung-Hung CHEN, Taichung City (TW)

(21) Appl. No.: 18/991,333

(22) Filed: Dec. 20, 2024

(30) Foreign Application Priority Data
Oct. 7, 2024 (TW) 113138164

(51) Int. Cl. H04N 23/55

(52) U.S. Cl. CPC H04N 23/55

(57) ABSTRACT

A lens module includes a lens barrel, an optical lens assembly, a light shielding sheet and an optical sensor. The optical lens assembly is disposed in the lens barrel, and includes at least one lens. The light shielding sheet is disposed in the lens barrel and closer to an object side than the lens. The optical sensor is disposed in the lens barrel and located on an image plane. The light shielding sheet includes an annular body having an outer periphery and an inner periphery. The outer periphery surrounds the inner periphery, and an opening is formed around the inner periphery. The outer periphery includes first and second cut edges, which are respectively contracted toward a center of the light shielding sheet along the Y-axis. The inner periphery includes third and fourth cut edges, which are respectively contracted toward the center of the light shielding sheet along the Y-axis.

This application claims the benefit of Taiwan Patent Application No. 113138164, filed on Oct. 7, 2024, which is hereby incorporated by reference for all purposes as if fully set forth herein.

### BACKGROUND

### Technical Field

The present disclosure relates to a lens module, and in particular to an electronic device having a lens module.

### Related Art

The shooting function is already an indispensable function for terminal electronic devices (such as mobile phones, laptops, tablets, etc.). In order to obtain good image quality and camera effects, lens modules are installed in electronic devices to provide an extensive shooting function. Electronic devices emphasize the ratio of screen to body, and the front of a general electronic device not only has the display screen, but also has components such as front lens modules, which affects the ratio of screen to body according to the electronic device.

Currently, lightness, thinness and narrow frame of electronic devices are industry development needs. The lens module is usually disposed on the frame of the display screen of the electronic device. Since the lens module has a certain height and width, when the lens module is disposed on the frame of the display screen of the electronic device, it is difficult for the electronic device to achieve a narrow frame. The narrow frame will also increase the thickness of the electronic device and makes the electronic device difficult to achieve thinness and lightness.

An imaging circle of the lens module is usually larger than the size of the optical sensor, and currently it is a major design trend to contract the lens module in the specific direction to increase the ratio of screen to body. However, when the lens module 9 (shown in FIG. 1) in the prior art is contracted in the specific direction, additional stray light may be generated, for example stray light hits the outside of the lens at a large angle.

Thus, a lens module and an electronic device need to be provided for meeting previous requirements.

### SUMMARY

An objective of the present disclosure is to provide a light shielding sheet of a lens module, which has a non-traditional annular structure in a specific direction.

To achieve the above objective, the present disclosure provides a lens module, defining a central axis, an X axis, a Y axis, an object side and an image side, wherein the central axis, the X axis and the Y axis are perpendicular to each other, the image side is opposite to the object side, and the lens module comprises: a lens barrel; an optical lens assembly disposed in the lens barrel, wherein the optical lens assembly includes at least one lens; a light shielding sheet disposed in the lens barrel and being closer to the object side than the lens; and an optical sensor disposed in the lens barrel and located on an image plane; wherein the light shielding sheet includes an annular body having an outer periphery and an inner periphery, the outer periphery surrounds the inner periphery, and an opening is formed around the inner periphery; the outer periphery includes first and second cut edges, which are respectively contracted toward a center of the light shielding sheet along the Y-axis, and the inner periphery includes third and fourth cut edges, which are respectively contracted toward the center of the light shielding sheet along the Y-axis; and the distance between the first and second cut edges is D2, the distance between the third and fourth cut edges is D1, and the following conditions are satisfied: 0.05≤D1/D2≤0.95.

The present disclosure further provides an electronic device, comprising: a housing; the above-mentioned lens module disposed in the housing, and a control component disposed in the housing and electrically connected to the optical sensor.

The light shielding sheet of the present disclosure has a non-traditional annular structure in a specific direction, which can solve the stray light in the specific direction of the Y-axis or the X-axis and improve an image quality of the lens module.

### BRIEF DESCRIPTION OF THE DRAWINGS

FIG. 1 is a schematic sectional view of a lens module in the prior art.

FIG. 2 is a schematic sectional view of a lens module according to an embodiment of the present disclosure.

FIG. 3 is a schematic exploded perspective view of a lens module according to an embodiment of the present disclosure.

FIG. 4 is a schematic front view of a lens module according to an embodiment of the present disclosure.

FIG. 5 is a schematic perspective view of a light shielding sheet of a lens module according to an embodiment of the present disclosure.

FIG. 5a is a schematic plan view of the light shielding sheet of the lens module according to the first embodiment of the present disclosure.

FIG. 5b is a schematic plan view of the light shielding sheet of the lens module according to the second embodiment of the present disclosure.

FIG. 5c is a schematic plan view of the light shielding sheet of the lens module according to the third embodiment of the present disclosure.

FIG. 5d is a schematic plan view of the light shielding sheet of the lens module according to the fourth embodiment of the present disclosure.

FIG. 5e is a schematic plan view of the light shielding sheet of the lens module according to the fifth embodiment of the present disclosure.

FIG. 6a to FIG. 6d are schematic diagrams showing four relationships between the size of the optical sensor and an imaging area of the lens module according to an embodiment of the present disclosure.

FIG. 7a to FIG. 7e are schematic diagrams comparing the lens module in the prior art with the lens module in other embodiments of the present disclosure.

FIG. 8 is a schematic sectional view of an electronic device according to an embodiment of the present disclosure.

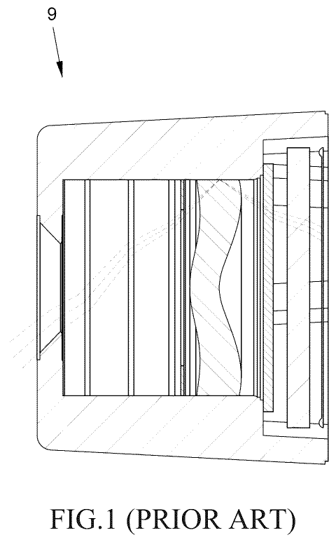

### DETAILED DESCRIPTION

To make the foregoing objectives, characteristics and features of the present disclosure more comprehensible, preferred embodiments of the present disclosure are described in detail below with reference to the accompanying drawings.

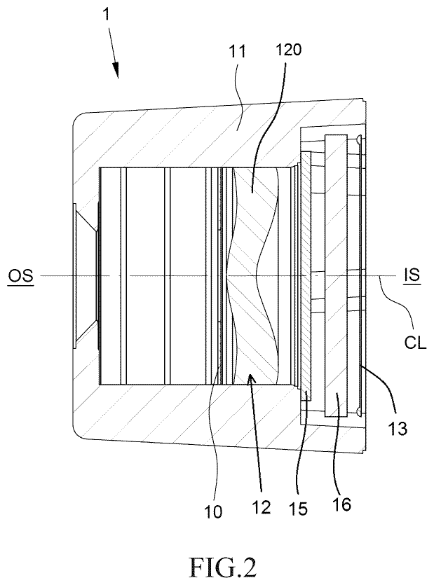

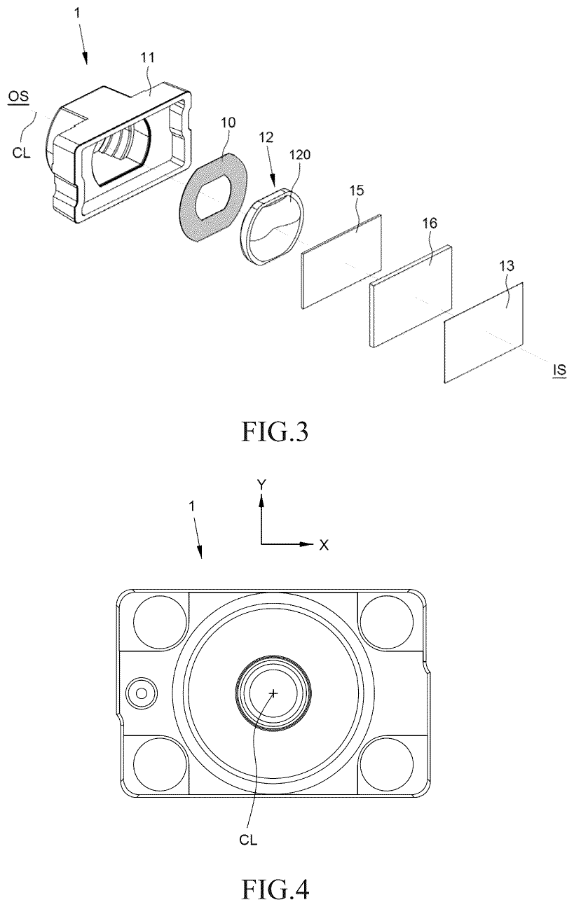

FIG. 2 is a schematic sectional view of a lens module according to an embodiment of the present disclosure. FIG. 3 is a schematic exploded perspective view of a lens module according to an embodiment of the present disclosure. FIG. 4 is a schematic front view of a lens module according to an embodiment of the present disclosure. Referring to FIG. 2, FIG. 3 and FIG. 4, the lens module 1 defines a central axis CL, an X axis, a Y axis, an object side OS and an image side IS. The central axis CL, the X axis, the Y axes are perpendicular to each other, and the image side IS is opposite to the object side OS. The lens module 1 includes: a lens barrel 11, an optical lens assembly 12, a light shielding sheet 10 and an optical sensor 13.

Refer to FIG. 2 and FIG. 3 again, the optical lens assembly 12 is disposed in the lens barrel 11, wherein the optical lens assembly 12 includes at least one lens 120. For example, the optical lens assembly 12 includes a plurality of lenses 120, such as a first lens to an N-th lens. The N-th lens is the lens of the optical lens assembly 12 that is the closest to the image side IS, and N is an integer greater than zero. The light shielding sheet 10 is disposed in the lens barrel 11 and closer to the object side OS than the lens 120. In this embodiment, the light shielding sheet 10 can be an aperture stop or a stop configured to correct edge light. The lens module 1 further includes a plurality of optical elements arranged in the lens barrel 11, and the optical elements can be an optical filter, such as an infrared optical filter, an infrared bandpass optical filter, or other optical band filters, etc.

The optical sensor 13 is disposed in the lens barrel 11 and is located on an image plane. The optical sensor 13 may be an image sensor. The lens module 1 further includes: an optical filter 15 and a protective glass sheet 16, which are sequentially disposed between the optical lens assembly 12 and the optical sensor 13.

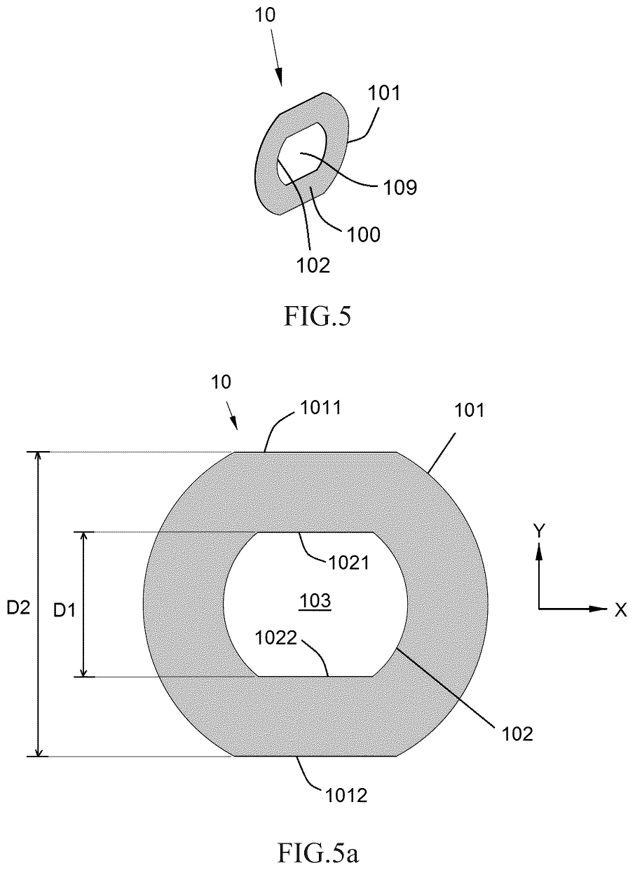

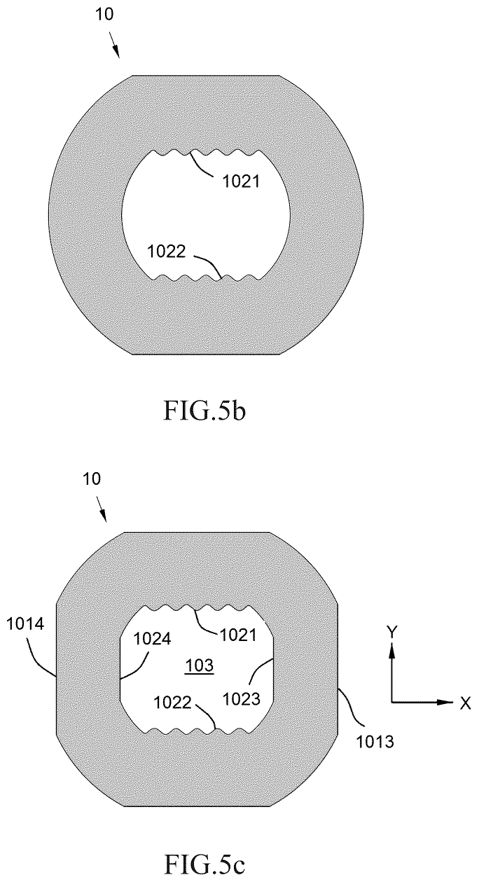

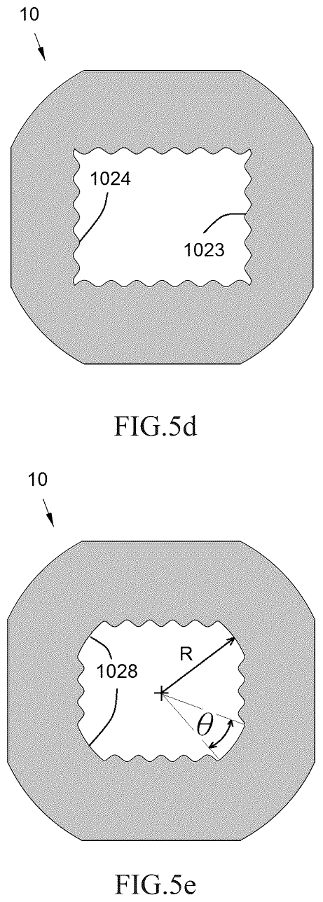

FIG. 5 is a schematic perspective view of a light shielding sheet of a lens module according to an embodiment of the present disclosure. FIG. 5a is a schematic plan view of the light shielding sheet of the lens module according to the first embodiment of the present disclosure. Referring to FIG. 5 and FIG. 5a, the light shielding sheet 10 includes an annular body 100 having an outer periphery 101 and an inner periphery 102. The outer periphery 101 surrounds the inner periphery 102, and an opening 109 is formed around the inner periphery 102; the outer periphery 101 includes a first cut edge 1011 and a second cut edge 1012, which are respectively contracted along the Y axis toward the center 103 (i.e., the position close to the central axis CL in FIG. 4) of the light shielding sheet 10, the inner periphery 102 includes a third cut edge 1021 and a fourth cut edge 1022, which are respectively contracted toward the center 103 of the light shielding sheet 10 along the Y-axis; and, the distance between the first cut edge 1011 and the second cut edge 1012 is D2, and the distance between the third cut edge 1021 and the fourth cut edge 1022 is D1, and the following conditions are satisfied: 0.05≤D1/D2≤0.95. All of the first to fourth cut edges 1011, 1012, 1021, and 1022 have a flat surface. The distance D2 between the first cut edge 1011 and the second cut edge 1012 is between 2.670±0.267 mm, but not limited thereto; preferably, the distance D2 is 2.67 mm. The distance D1 between the third cut edge 1021 and the fourth cut edge 1022 is between 1.737±0.174 mm, but not limited thereto; preferably, the distance D1 is 1.737 mm.

Since the lens module in the prior art is contracted along the Y-axis, additional stray light may be generated, for example, stray light hits the outside of the lens at a large angle. The design of the light shielding sheet of the present disclosure can block this large-angle stray light to solve the problem of the additional stray light generated by the lens module, thereby improving an image quality of the lens module.

FIG. 5b is a schematic plan view of the light shielding sheet of the lens module according to the second embodiment of the present disclosure. Referring to FIG. 5 and FIG. 5b, the light shielding sheet 10 in the second embodiment is generally similar to the light shielding sheet 10 in the first embodiment. The difference is that the third cut edge 1021 and the fourth cut edge 1022 have a wavy surface, which can scatter light to solve the problem of the stray light, thereby improving an image quality of the lens module.

FIG. 5c is a schematic plan view of the light shielding sheet of the lens module according to the third embodiment of the present disclosure. Referring to FIG. 5 and FIG. 5c, the light shielding sheet 10 in the third embodiment is generally similar to the light shielding sheet 10 of the second embodiment. The difference is that the outer periphery 101 further includes a fifth cut edge 1013 and a sixth cut edge 1014, which are respectively contracted toward the center 103 of the light shielding sheet 10 along the X-axis, and the inner periphery 102 further includes a seventh cut edge 1023 and an eighth cut edge 1024, which are respectively contracted toward the center 103 of the light shielding sheet 10 along the X-axis. The third cut edge 1021 and the fourth cut edge 1022 have a wavy surface, which can scatter light to solve the problem of the stray light. In order to save space in the lens module in the prior art, the lens module of the present disclosure is also contracted along the X-axis, which may also produce additional stray light. However, the light shielding sheet of the present disclosure can be used to block the stray light, thereby improving an image quality of the lens module.

FIG. 5d is a schematic plan view of the light shielding sheet of the lens module according to the fourth embodiment of the present disclosure. Referring to FIG. 5 and FIG. 5d, the light shielding sheet 10 in the fourth embodiment is substantially similar to the light shielding sheet 10 in the first embodiment. All of the third cut edge 1021, the fourth cut edge 1022, the seventh cut edge 1023 and the eighth cut edge 1024 have a wavy surface, which can scatter light to solve the problem of the stray light, thereby improving an image quality of the lens module.

FIG. 5e is a schematic plan view of the light shielding sheet of the lens module according to the fifth embodiment of the present disclosure. Referring to FIG. 5 and FIG. 5e, the light shielding sheet 10 in the fifth embodiment is substantially similar to the light shielding sheet 10 in the fourth embodiment. The difference is that the inner periphery 102 further includes four corners 1028, which respectively form diagonal arcs. For example, the arc radius is R, and the following conditions are satisfied: 0.03 mm≤R≤∞. The central angle of the arc is θ, and the following conditions are satisfied: 10°≤θ≤80°.

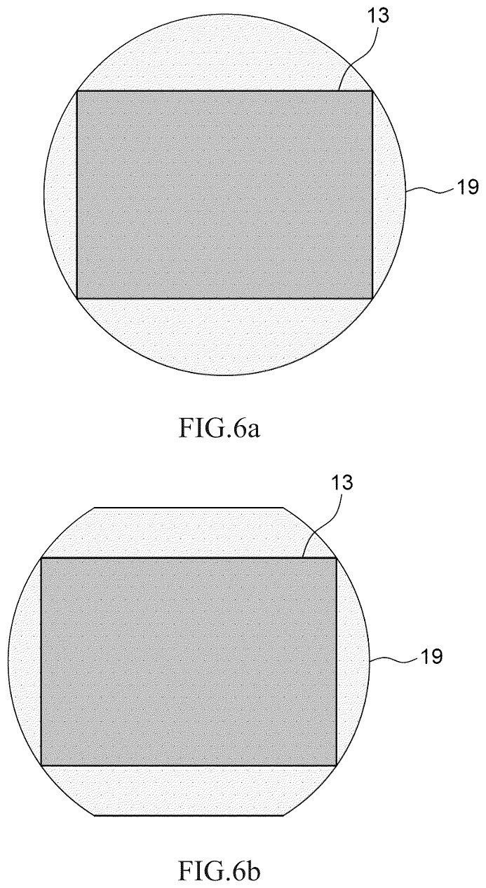

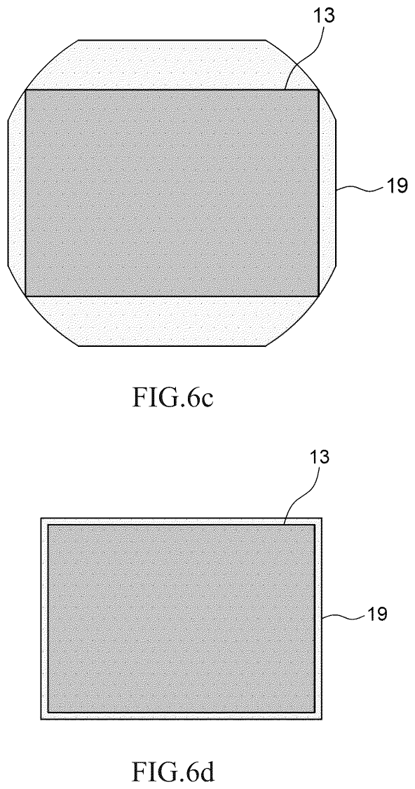

FIG. 6a to FIG. 6d are schematic diagrams showing four relationships between the size of the optical sensor and an imaging area of the lens module according to an embodiment of the present disclosure. The size of the optical sensor 13 is usually set to an aspect ratio of 3:4 or 9:16, but is not limited thereto; and the imaging area 19 is usually larger than the size of the optical sensor 13. Referring to FIG. 6a, when the size of the lens module is only reduced to the position outside the lens barrel, the imaging area 19 is still a complete circle without sacrificing the range of the imaging area 19. Referring to FIG. 6b and FIG. 4, when the size of the lens module is reduced along the Y-axis to the position of the non-optical area of the optical lens assembly, part of the range of the imaging area 19 in the specific direction of the Y-axis is sacrificed. Referring to FIG. 6c and FIG. 4, when the size of the lens module is reduced along the Y-axis and X-axis to the position of the non-optical area of the optical lens assembly, part of the imaging area 19 in the specific directions of the Y-axis and X-axis is sacrificed. Referring to FIG. 6d and FIG. 4, when the size of the lens module is reduced along the Y-axis and X-axis to the position of the non-optical area of the optical lens assembly, most of the imaging area 19 in the specific directions of the Y-axis and X-Axis is sacrificed.

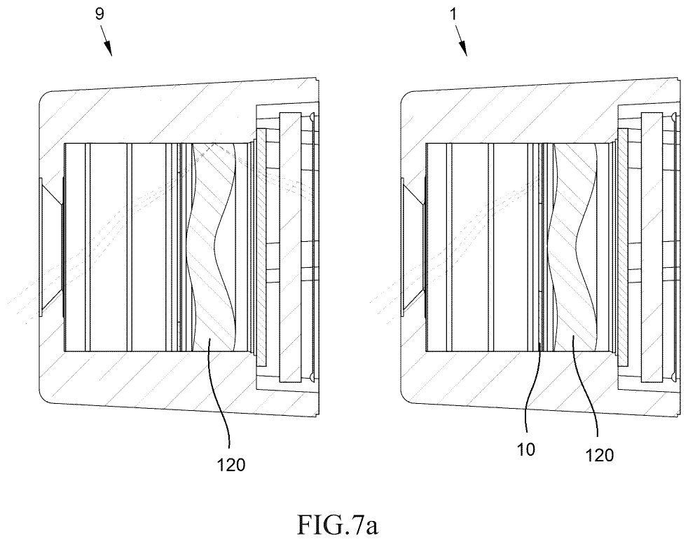

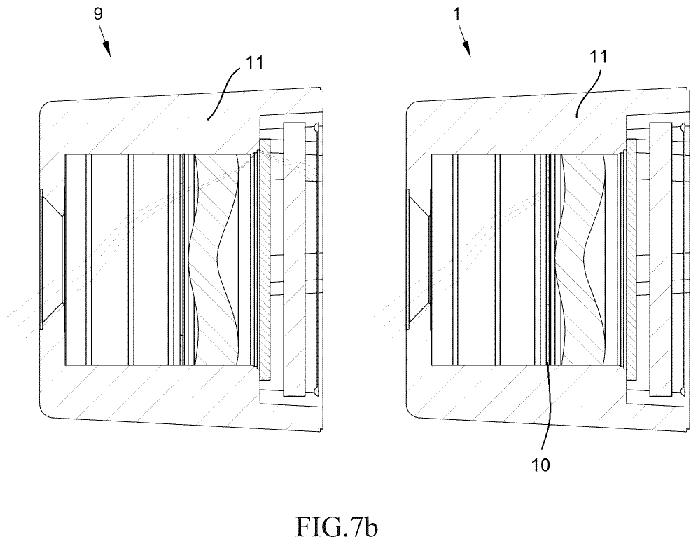

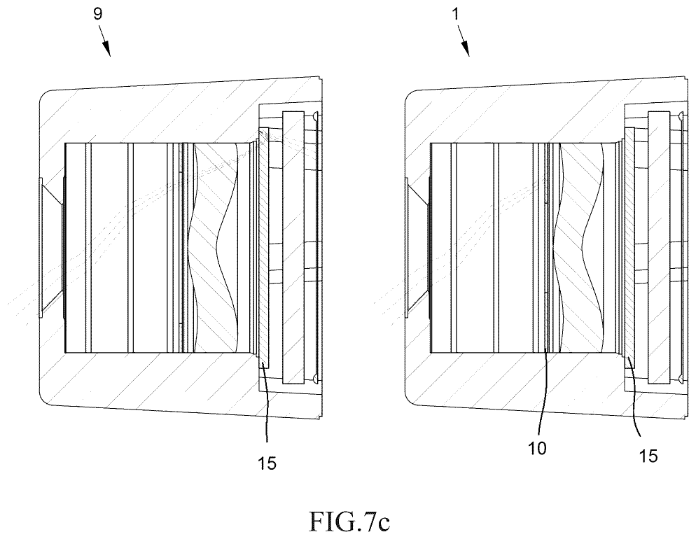

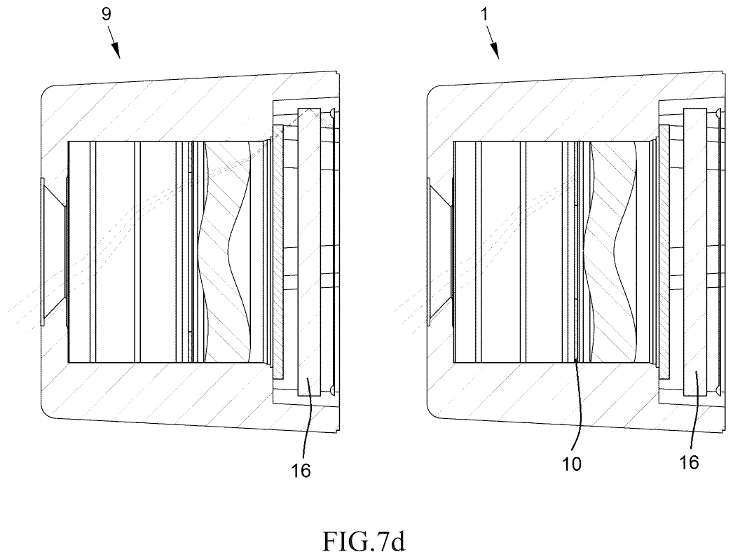

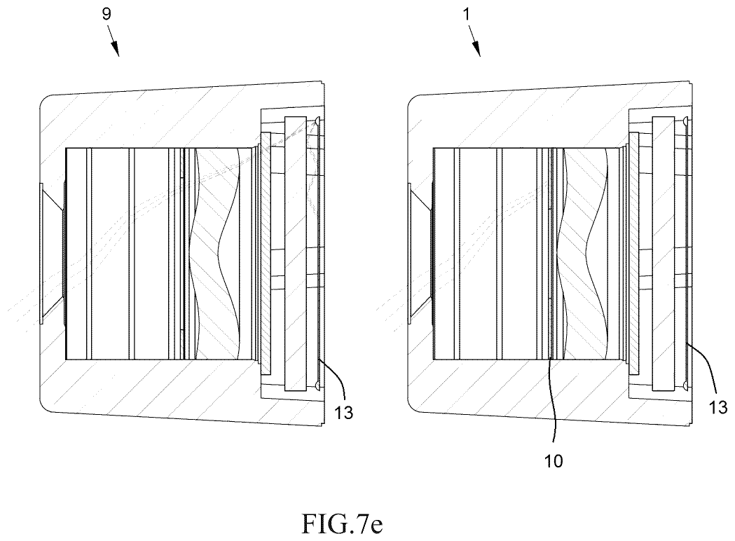

FIG. 7a to FIG. 7e are schematic diagrams comparing the lens module in the prior art with the lens module in other embodiments of the present disclosure. Referring to FIG. 7a, a path of the stray light of the lens module 9 in the prior art reaches an outside of the lens 120, but the lens module 1 of the present disclosure solves the problem of the stray light hitting the outside of the lens 120. Referring to FIG. 7b, a path of the stray light of the lens module 9 in the prior art reaches a side wall of the lens barrel 11, but the lens module 1 of the present disclosure solves the problem of the stray light hitting the side wall of the lens barrel 11. Referring to FIG. 7c, a path of the stray light of the lens module 9 in the prior art reaches a side wall of the optical filter 15, but the lens module 1 of the present disclosure solves the problem of the stray light hitting the side wall of the optical filter 15. Referring to FIG. 7d, a path of the stray light of the lens module 9 in the prior art reaches a side wall of the protective glass sheet 16, but the lens module 1 of the present disclosure solves the problem of the stray light hitting the side wall of the protective glass sheet 16. Referring to FIG. 7e, a path of the stray light of the lens module 9 in the prior art reaches a gold wire of the optical sensor 13, but the lens module 1 of the present disclosure solves the problem of the stray light hitting the gold wire of the optical sensor 13. When the light shielding sheet 10 of the present disclosure is designed according to the above embodiments, the light shielding sheet 10 can block the stray light at a large angle. The stray light are intercepted to improve image quality, before the stray light hit the outside of the lens 120, the side wall of the lens barrel 11, the side wall of the optical filter 15, and the side wall of the protective glass sheet 16 or the gold wire of the optical sensor 13. Therefore, the light shielding sheet of the present disclosure has a non-traditional annular structure in a specific direction, which can solve the problem of the stray light in a specific direction of the Y-axis or X-axis and improve an image quality of the lens module.

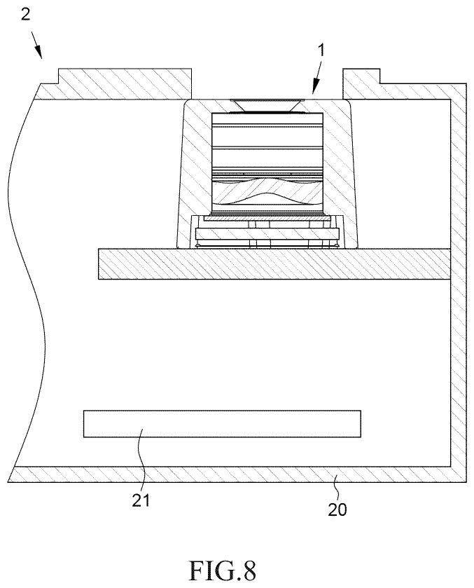

FIG. 8 is a schematic sectional view of an electronic device according to an embodiment of the present disclosure. The electronic device 2 includes: a housing 20, the lens module 1 of the present disclosure, and a control component 21. The lens module 1 is disposed in the housing 20. The control component 21 is disposed in the housing 20 and is electrically connected to the optical sensor of the lens module 1. The electronic device 2 of the present disclosure can be a mobile phone, a laptop, etc. In addition, the lens module provided by the present disclosure may be used in photography, surveillance, automation equipment, vehicle surround systems, and electronic imaging systems in the internet of things (IOT) equipment, but is not limited thereto.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. A lens module, defining a central axis, an X axis, a Y axis, an object side and an image side, wherein the central axis, the X axis and the Y axis are perpendicular to each other, the image side is opposite to the object side, and the lens module comprises:
a lens barrel;
an optical lens assembly disposed in the lens barrel, wherein the optical lens assembly includes at least one lens;
a light shielding sheet disposed in the lens barrel and being closer to the object side than the lens; and
an optical sensor disposed in the lens barrel and located on an image plane;
wherein the light shielding sheet includes an annular body having an outer periphery and an inner periphery, the outer periphery surrounds the inner periphery, and an opening is formed around the inner periphery;
the outer periphery includes first and second cut edges, which are respectively contracted toward a center of the light shielding sheet along the Y-axis, and the inner periphery includes third and fourth cut edges, which are respectively contracted toward the center of the light shielding sheet along the Y-axis; and
the distance between the first and second cut edges is D2, the distance between the third and fourth cut edges is D1, and the following conditions are satisfied: 0.05≤D1/D2≤0.95.

2. The lens module according to claim 1, wherein the distance between the first cut edge and the second cut edge is between 2.670±0.267 mm, and the distance between the third cut edge and the fourth cut edge is between 1.737±0.174 mm.

3. The lens module according to claim 1, wherein all of the first to fourth cut sides have a flat surface.

4. The lens module according to claim 3, wherein both of the third and fourth cut edges have a wavy surface.

5. The lens module according to claim 1, wherein the outer periphery further includes fifth and sixth cut edges, which are respectively contracted toward the center of the light shielding sheet along the X-axis, and the inner periphery further includes seventh and eighth cut edges, which are respectively contracted toward the center of the light shielding sheet along the X-axis.

6. The lens module according to claim 5, wherein all of the third, fourth, seventh and eighth cut edges have a wavy surface.

7. The lens module according to claim 6, wherein the inner periphery further includes four corners, respectively forming diagonal arcs.

8. The lens module according to claim 7, wherein the arc radius is R, and the following conditions are satisfied: 0.03 mm≤R≤∞.

9. The lens module according to claim 7, wherein the central angle of the arc is θ, and the following conditions are satisfied: 10°≤θ≤80°.

10. An electronic device, comprising:
a housing;
a lens module disposed in the housing, wherein:
the lens module defines a central axis, an X axis, a Y axis, an object side and an image side, wherein the central axis, the X axis and the Y axis are perpendicular to each other, the image side is opposite to the object side, and the lens module comprises:
a lens barrel;
an optical lens assembly disposed in the lens barrel, wherein the optical lens assembly includes at least one lens;
a light shielding sheet disposed in the lens barrel and located on an object-side surface of the lens; and
an optical sensor disposed in the lens barrel and located on an image plane;
wherein the light shielding sheet includes an annular body having an outer periphery and an inner periphery, the outer periphery surrounds the inner periphery, and an opening is formed around the inner periphery;
the outer periphery includes first and second cut edges, which are respectively contracted toward a center of the light shielding sheet along the Y-axis, and the inner periphery includes third and fourth cut edges, which are respectively contracted toward the center of the light shielding sheet along the Y-axis; and
the distance between the first and second cut edges is D2, the distance between the third and fourth cut edges is D1, and the following conditions are satisfied: 0.05≤D1/D2≤0.95; and
a control component disposed in the housing and electrically connected to the optical sensor.

11. The electronic device according to claim 10, wherein the distance between the first cut edge and the second cut edge is between 2.670±0.267 mm, and the distance between the third cut edge and the fourth cut edge is between 1.737±0.174 mm.

12. The electronic device according to claim 10, wherein all of the first to fourth cut sides have a flat surface.

13. The electronic device according to claim 12, wherein both of the third and fourth cut edges have a wavy surface.

14. The electronic device according to claim 10, wherein the outer periphery further includes fifth and sixth cut edges, which are respectively contracted toward the center of the light shielding sheet along the X-axis, and the inner periphery further includes seventh and eighth cut edges, which are respectively contracted toward the center of the light shielding sheet along the X-axis.

15. The electronic device according to claim 14, wherein all of the third, fourth, seventh and eighth cut edges have a wavy surface.

16. The electronic device according to claim 15, wherein the inner periphery further includes four corners, respectively forming diagonal arcs.

17. The electronic device according to claim 16, wherein the arc radius is R, and the following conditions are satisfied: 0.03 mm≤R≤∞.

18. The electronic device according to claim 16, wherein the central angle of the arc is θ, and the following conditions are satisfied: 10°≤θ≤80°.
